(19) United States
(12) Patent Application Publication
(10) Pub. No.: US 2005/0168192 A1
(43) Pub. Date: Aug. 4, 2005

(54) Battery pack

(75) Inventors: Kazuhisa Nagase, Utsunomiya-Shi (JP); Shin Suzuki, Utsunomiya-Shi (JP); Shuji Shibata, Utsunomiya-Shi (JP); Shingo Takahashi, Utsunomiya-Shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NEC TOKIN CORPORATION, Sendai-shi (JP); NEC TOKIN TOCHIGI, LTD., Utsunomiya-Shi (JP)

(21) Appl. No.: 11/044,563

(22) Filed: Jan. 28, 2005

(30) Foreign Application Priority Data
Feb. 2, 2004 (JP) 2004-024960

(51) Int. Cl. H02J 7/00

(52) U.S. Cl. 320/132

(57) ABSTRACT

The invention provides a battery pack 2 operatively associated with a main system 1 for charge-level data sharing between them for recording and management. The battery pack 2 includes recorder means 22 that is connected to the main system 1 for writing to and reading out of the main system 1. Charge-level data measured (12, 14) and calculated (13) at at least the main system 1 are written to and read out of the recorder means 22 by way of signal lines. The battery pack 2 is not provided with any means for management of the charge-level data, making cost and size reductions possible.

### BACKGROUND OF THE INVENTION

The present invention is concerned with a battery pack for charge data sharing between a main system and a battery for recording and management.

Commonly, a battery pack used as a power source for a main electronic system such as notebook PCs, cellular phones, video cameras and digital cameras has a built-in CPU for protection of overcharge and overdischarge and charge-level management, which is operable to communicate with a main unit (external unit) for transmission and reception of information (for instance, see JP(A)'s 2002-42897 and 2002-100414.

FIG. 1 is illustrative in schematic of the architecture of a prior art battery pack capable of charge-level management. The conventional battery pack 2 comprises a battery element 23, an inevitable protective circuit 21, a battery pack control system 25 adapted to calculate available charge for battery charge management, a voltage-measurement element 24 necessary for charge level calculation, a current-measurement element 26, signal lines for transmission of measurements obtained at the voltage-measurement element 24 and current-measurement element 26 to the battery pack control system 25, and a charge-level recorder 22 for recording charge-level data, etc. In association with these, a main system 1 comprises a main load 11 and an associated charge level management system 15 for managing the battery pack.

The battery pack 2 and the main system 1 are electrically connected together by way of a power source line and communication lines, so that communications can take place between the battery pack control system 25 in the battery pack 2 and the charge-level management system 15 in the main system 1, thereby transmitting charge-level data or the like calculated at the battery pack 2 to the main system 1.

### SUMMARY OF THE INVENTION

When it comes to the aforesaid battery pack 2, the function of charge management by the battery pack control system 25 is of the self-contained type, so that even though the battery pack 2 is of the detachable type, the amount of available charge can be managed on the battery pack 2 by itself. However, this means that there are two systems of similar functionality throughout the battery pack 2 and the main system 1, rendering the battery pack 2 very expensive.

When it comes to a battery pack incapable of charge management, on the other hand, the voltage of the battery pack will be measured on the main system side for charge management. In such a case, if the amount of available charge is in proportion to the voltage value of the battery pack, that amount could be managed with relatively high precision. However, when the battery pack has no such proportional relations, the management information on the main system side is nothing more than an index. In other words, such a battery pack cannot often be used in applications for which some accuracy is in need.

A primary object of the invention is to provide a solution to the aforesaid problems by enabling charge management without using charge management means in a battery pack, thereby reducing the cost and size of the battery pack.

Thus, the present invention provides a battery pack operatively associated with a main system for charge-level data sharing therebetween for recording and management of said data, characterized by comprising recorder means connected to said main system by way of a plurality of communication lines for writing to and reading out of said main system, wherein charge-level data measured and calculated at at least said main system are written to and read out of said recorder means.

The present invention is further characterized in that said charge-level data as well as associated data about management information on said battery pack are recorded in said recorder means, at least one of the number of charge/discharge cycles, ID code, lot number and serial number of said battery pack is included as said management information, and a power source necessary for operation of said recorder means is supplied from said main system by way of a power source line.

The present invention is further characterized in that said charge-level data are sent out of said main system each time changes occur depending on fluctuations based on charge/discharge, and written to at least three addresses.

The present invention is further characterized in that said recorder means includes a charge-level indicator portion, wherein said charge-level indicator portion includes latch means for holding said charge-level data and LED indicator means adapted to be put on by way of a signal from an indicator switch or said main system.

With the inventive battery pack operatively associated with a main system for charge-level data sharing therebetween for recording and management, characterized by comprising recorder means connected to said main system by way of a plurality of communication lines for writing to and reading out of said main system, wherein charge-level data measured and calculated at at least said main system are written to and read out of said recorder means, charge can be managed by writing and reading of charge-level data from the main system outside of the battery pack without incorporating any charge-level management means in the battery pack, so that the cost and size of the battery pack can be considerably reduced.

With one embodiment of the invention wherein said charge-level data as well as associated data about management information on said battery pack are recorded in said recorder means, at least one of the number of charge/discharge cycles, ID code, lot number and serial number of said battery pack is included as said management information, and a power source necessary for operation of said recorder means is supplied from said main system by way of a power source line, it is possible to minimize the amount of circuitry needed in the battery pack, thereby achieving further cost and size reductions of the battery pack.

With another embodiment of the invention wherein said charge-level data are sent out of said main system each time changes occur depending on fluctuations based on charge/discharge, and written to at least three addresses, it is possible to retain constantly the most up-to-date charge-level data and make errors on writing, if any, correctable, thereby retaining the charge-level data with high accuracy.

With yet another embodiment of the invention wherein said recorder means includes a charge-level indicator portion, wherein said charge-level indicator portion includes latch means for holding said charge-level data and LED indicator means adapted to be put on by way of a signal from an indicator switch or said main system, it is possible to indicate available charge level at the necessary timing with simple arrangement.

Still other objects and advantages of the invention will in part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is schematically illustrative of the construction of a prior art battery-pack capable of charge-level management.

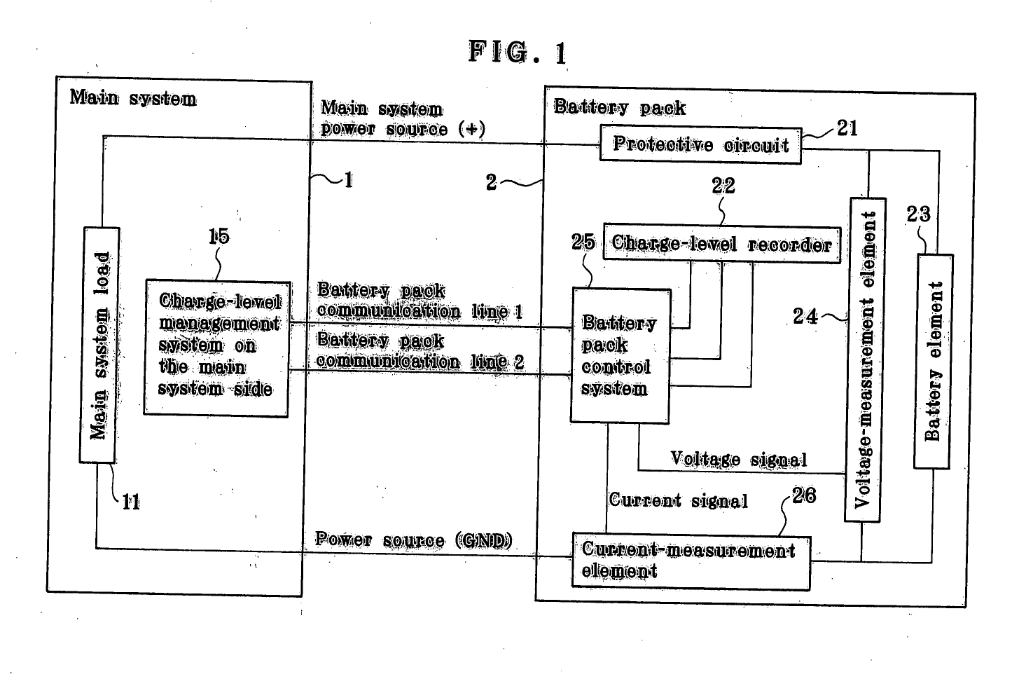

FIG. 2 is illustrative of one embodiment of the battery pack according to the invention,

### DESCRIPTION OF THE PREFERRED EMBODIMENTS

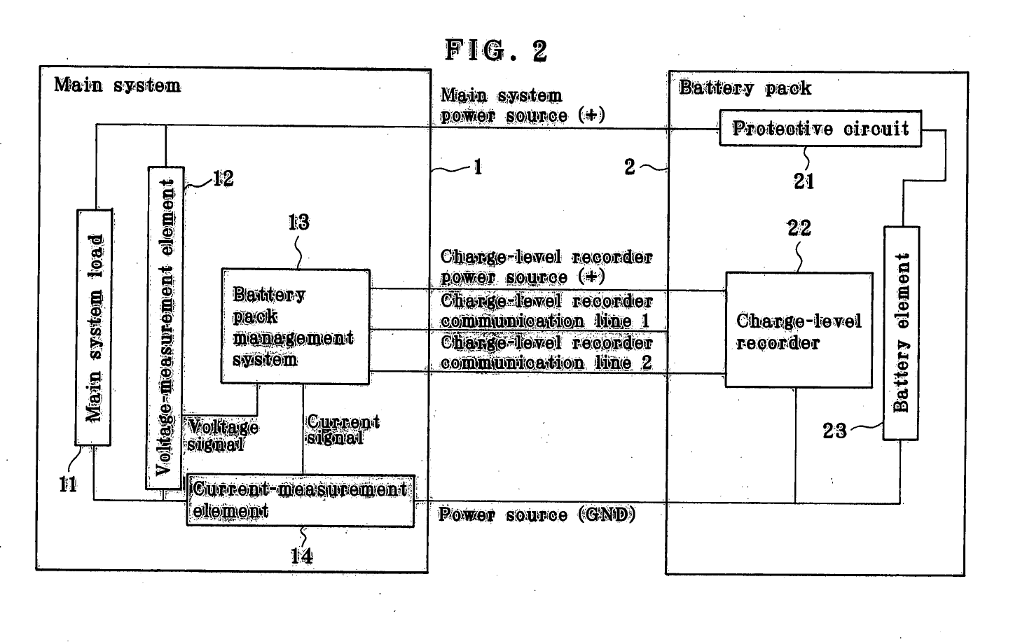

Embodiments of the present invention are now explained with reference to the accompanying drawing. FIG. 2 is schematically illustrative of one embodiment of the battery pack according to the invention. Reference numeral 1 stands for an electronic main system, 2 a battery pack, 11 a main system load, 12 a voltage-measurement element, 13 a battery pack management system, 14 a current-measurement element, 21 a protective circuit, 22 a charge-level recorder, and 23 a battery element.

As shown in FIG. 2, the battery pack 2 comprises a battery element 23, a protective circuit 21 for providing protection of overcharge, overdischarge, overcurrent and overheating if required, and a charge-level recorder 22 for recording data on the available charge of battery element 23, and so on. On the other hand, the main system 1 that is discharged with the battery pack 2 as a power source or charges the battery pack 2 comprises main system load 11 that is a main system unit, a voltage-measurement element 12 for measuring the voltage necessary for calculation of available charge, a current-measurement element 14 for measurement of currents, and a battery pack management system 13 for calculating the available charge of the battery element based on voltage and current measurements for management. If the main system 1 has an added charging function or a charger, the main system load 11 is replaced by a charge power source to charge the battery pack 2.

Between the battery pack 2 and the main system 1 connections are made by a power feed line comprising a ground GND (−) common to the (+) of a power source, a charge-level reorder power source line (+) and communication lines comprising charge-level recorder communication lines 1 and 2. The charge-level recorder 22 is fed with the power source necessary for operation from the battery pack management system 13 by way of the charge-level recorder power source line (+), so that charge-level data calculated through the communication lines comprising charge-level recorder communication lines 1 and 2 can be written to or read into the charge-level recorder 22. The charge-level recorder communication lines 1 and 2 are directly connected between the charge-level recorder 22 and the battery pack management system 13 for connection with means for fending off external noises, static electricity, and so on. Thus, nowhere in the battery pack 2 is the charge-level recorder 22 connected in circuit terms; the terminal necessary for operation is provided for external connection, so that by way of the main system (equipment that becomes load or a charger) 1, power source can be fed to a rewritable memory and data can be read out of or written to that rewritable memory.

With the battery pack 2 attached to the unit of main system 1, that unit, i.e., the battery pack management system 13 in the main system 1 is operable to read out the charge-level data recorded in the charge-level recorder 22 in the battery pack 2. Then, as discharge takes place from the battery pack 2 toward the main system 1, the amount of discharge is successively subtracted from the available charge at the battery pack management system 13 in the main system 1, and as charge occurs from the main system 1 toward the battery pack 2, the amount of charge is added at the battery pack management system 13 in the main system 1.

At the battery pack management system 13, the value of charge-level data read out of the charge-level recorder 22 fluctuates depending upon charge or discharge, and a new value is written to the charge-level recorder 22 each time the value of charge-level data changes depending on such fluctuations. This ensures that even though the battery pack 2 is removed off in the course of charge or discharge, the value of charge-level data recorded in the charge-level recorder 22 can be kept invariable.

To provide the value of charge-level data recorded in the charge-level recorder 22 with much higher reliability, it is required to prevent detachment of the battery pack 2 at the timing of writing the charge-level data from the battery pack management system 13 thereto, and make errors on writing, if any, correctable. To this end, the charge-level recorder 22 in the battery pack 2 should be set in such a way as to carry a sign of “data being written” and write the same data thereto at three preset addresses.

This ensures prevention of removal of the battery pack 2 while the data are being written, and enables errors on writing to one datum, if any, to be corrected on a majority rule basis with charge-level data at, e.g., three addresses. In addition, it is acceptable to provide a locking mechanism for an attachment/detachment switch.

According to the instant embodiment as described above, it is possible to provide a battery pack at lower costs, because the charge-level management system that has so far been installed in a battery pack is built in the main system. Still, only the charge-level recorder is held in the battery pack so as to record charge-level data therein. This is because only with charge-level data transmitted from one battery pack management system for recording, that charge-level data cannot be recorded in the battery pack, when separated from the main system.

As a rewritable memory, for instance, an EEPROM is used for the charge-level recorder, costs inclusive of those of antinoise and antistatic means can be much more reduced even at a storage capacity of the order of 1 Kword. Although depending on the storage capacity of the charge-level recorder, not only can the charge-level data be stored but also the number of charge/discharge cycles of the battery pack can be recorded, thereby enhancing the accuracy of charge-level management. It is further possible to record associated information such as the ID, lot, serial number, time data, etc. of the battery pack. For instance, when the charge level is expressed in increments of 1% up to 100%, 0 up to 156, to say nothing of 02 to 100, can be expressed given 1 byte; a 1 Kword-storage capacity of the charge-level recorder is too good for such applications.

The main system is much more intelligent than the system incorporated in the battery pack, and can operate with a lot of capacity, and the charger serves to manage charge voltage, charge current and charge time as well. It is thus easy to calculate the amount of charge at the main system and the charger alike. In this connection, main systems required to have a battery pack equipped with a charge-level meter, for instance, include highly sophisticated notebook PCs, cellular phones, video cameras, and digital cameras. If, as in the instant embodiment, recorder means for recording management information on a battery pack such as charge-level data and associated data, e.g., the number of charge/discharge cycles, ID, lot, serial number and time (charge time and time of use) of the battery pack is built in the main system, increases in the cost of the main system are then rather smaller than decreases in the cost of the battery pack. Further, if battery packs are used on one main system, the cost of the whole main system can then be much more cut back, because they are capable of parallel connection with the main system or can be used as spare batteries.

While the present invention has been described with reference to one specific embodiment, it is understood that various modifications and alternations could be made thereto. In the above embodiment, for instance, the charge level calculated on the main system side is written to and read out of the charge-level recorder in the battery pack. In the case of LEDs (light-emitting diodes), LCDs (liquid crystal displays) and so on for which the level of available charge must be indicated, however, a latch IC could be used together with a signal line that delivers the charge level indicated to both the battery pack and the main system as in the charge-level recorder, so that the amount of available charge indicated can be stored in the latch IC. With the latch IC, an LED could be put on by way of signals from an indicator switch, the main system or the charger.

1. A battery pack used with a main system for charge-level data sharing therebetween for recording and management, comprising recorder means connected to said main system by way of a plurality of communication lines for writing to and reading out of said main system, wherein charge-level data measured and calculated at at least said main system are written to and read out of said recorder means.

2. The battery pack according to claim 1, wherein said charge-level data as well as associated data about management information on said battery pack are recorded in said recorder means.

3. The battery pack according to claim 2, wherein at least one of the number of charge/discharge cycles, ID, lot and serial number of said battery pack is included as said management information.

4. The battery pack according to claim 1, wherein said charge-level data are sent out of said main system each time changes occur depending on fluctuations based on charge/discharge.

5. The battery pack according to claim 1, wherein said charge-level data are written to at least three addresses.

6. The battery pack according to claim 1, wherein a power source necessary for operation of said recorder means is supplied from said main system by way of a power source line.

7. The battery pack according to claim 1, wherein said recorder means includes a charge-level indicator.

8. The battery pack according to claim 7, wherein said charge-level indicator portion includes latch means for holding said charge-level data and LED indicator means, wherein said LED indicator means is put on by way of a signal from an indicator switch or said main system.

9. The battery pack according to claim 1, wherein the amount of discharge is subtracted from said charge-level data upon discharging from said battery pack to said main system, and the amount of charge is added to said charge-level data upon charging from said main system to said battery pack.
